(19) United States
(12) Patent Application Publication
(10) Pub. No.: US 2003/0135744 A1
(43) Pub. Date: Jul. 17, 2003

(54) Method and system for programming a non-volatile device in a data processing system

(75) Inventor: Jason Robert Almeida, Morrisville, NC (US)

Correspondence Address: Joseph P. Lally, DEWAN & LALLY, L.L.P., P.O. Box 684749, Austin, TX, 78768-4749, US

(73) Assignee: International Business Machines Corporation, Armonk, NY (US)

(21) Appl. No.: 10/044,432

(22) Filed: Jan. 11, 2002

(51) Int. Cl. H04L 9/32

(52) U.S. Cl. 713/191

(57) ABSTRACT

A method and system for insure that code being loaded (flashed) into a flash memory card or other non-volatile storage device of a data processing system is authorized code. The system may include code comprising a kernel portion that transitions the system from a protected-mode to a real-mode and a user portion that includes the code to be loaded onto the flash card. In one embodiment, an asymmetric authentication scheme ensures that the code flashed into the flash card is verified as authorized while complying with the open-source requirements of the operating system. In this embodiment, the public key may become a part of the kernel portion, which is available for all to inspect, while the private key is known only to the user portion. The user portion may generate a signature that is encrypted using the private key. The signature may be generated algorithmically based upon characteristics of or information associated with the corresponding data processing system. The encrypted signature may then be passed as a parameter to the kernel portion, which decrypts the signature according to the public key. If the decrypted signature correctly identifies the system, the kernel potion of the code completes the transition to real-mode and then invokes real-mode flashing code to flash the card. In this manner, only a small portion of code is required to be compiled into the kernel while enabling the code to prevent unauthorized access to the kernel.

### BACKGROUND

1. Field of the Present Invention

The present invention generally relates to the field of data processing systems and more particularly to a system and method for securely programming a programmable nonvolatile storage element in a microprocessor-based data processing system.

2. History of Related Art

In the field of data processing systems, programmable nonvolatile storage elements such as flash memory cards (flash cards) are frequently employed to store code that is executed immediately after power is applied to the system. This code is responsible for performing basic system checks, establishing low-level communication with system hardware, and for loading the system's operating system (OS). The code typically includes some form of power on self test (POST) and basic I/O system (BIOS), which will both be familiar to those knowledgeable in ×86-type systems.

The POST and BIOS code may be updated from time to time to eliminate bugs or make other improvements. When an update occurs, it is highly desirable to be able to download the updated code to the flash card without having to remove it or otherwise open the system. Programs have been developed to program a flash memory card while it remains installed in the system. The process of programming a flash memory card is commonly referred to as “flashing” the card.

Flashing a card with POST/BIOS may be accomplished using an application program that executes a transition from a protected-mode to a real-mode to update the BIOS. Real-mode refers to a single-tasking-mode in which the running program has full and direct access to the computer's memory and peripherals. Protected-mode is an operating-mode (introduced with the 80286 microprocessor) that lets software use memory beyond 16-bit addressing (640 KB). Protected-mode also creates a protection scheme enabling multiple programs to share a common set of computer resources (such as system memory) without conflicting with each other.

In some operating systems, such as Linux®, kernel level privilege is required to transition the system from protected-mode to real-mode. Transferring into the kernel requires a system call or device driver referred to herein as kernel transition code. If the kernel transition code is modified, it may be necessary to recompile the kernel. Minimizing the frequency of recompilation implies minimizing the contents of the kernel transition code. Ideally, just the code sufficient to transition the system from protected-mode to real-mode and to invoke the flashing code would be included in the kernel transition code. The rest of the code could then be loaded after the transition to kernel-mode and the subsequent transfer to real-mode.

Unfortunately, designing the kernel transition code as described would raise a significant security issue. Any non-privileged or user-mode program could execute the transition code and load real-mode code to usurp control of the system. Moreover, if the operating system is an open source operating system (such as Linux®), the kernel-mode transition code would be freely available such that a programmer of any skill could corrupt the system.

It would therefore be desirable to implement a method and system in which updating the contents of a non-volatile storage device on a data processing system could be achieved without substantial interaction by the system's users and without jeopardizing system security. It would be further desirable if the implemented solution was able to authenticate the code being loaded into the flash card. It would be still further desirable if the implemented authentication code leveraged, to the extent possible, existing authentication methods.

### SUMMARY OF THE INVENTION

The problems identified above are in large part addressed by a method and system according to the present invention in which an application program is combined with authentication mechanism to insure that code being loaded (flashed) into a flash memory card or other non-volatile storage device of a data processing system is authorized code. The application program may include a kernel portion that transitions the system from a protected-mode to a real-mode and a user portion that includes a system call to access the kernel portion. In one embodiment, an asymmetric (public key/private key) authentication scheme ensures that the code flashed into the flash card is verified as authorized while complying with any open-source requirements of the operating system. In this embodiment, the public key may become a part of the kernel portion, which is available for all to inspect, while the private key is known only to the user portion. The user portion may generate a signature that is encrypted using the private key. The signature may be generated algorithmically based upon characteristics of or information associated with the system under consideration. The encrypted signature may then be passed as a parameter to the kernel portion, which decrypts the signature according to the public key. If the decrypted signature correctly identifies the system, the kernel portion of the code completes the transition to real-mode and invokes real-mode flashing code to flash the card. In this manner, only a small portion of code is required to be compiled into the kernel while still preventing unauthorized real mode access.

### BRIEF DESCRIPTION OF THE DRAWINGS

Other objects and advantages of the invention will become apparent upon reading the following detailed description and upon reference to the accompanying drawings in which:

FIG. 1 is a block diagram of selected elements of a data processing system suitable for use with one embodiment of the present invention;

FIG. 2 is a conceptual illustration of computer code for flashing a nonvolatile memory in a data processing system according to one embodiment of the present invention; and

FIG. 3 is a flow diagram of a method for programming non-volatile memory in a data processing system according to one embodiment of the invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

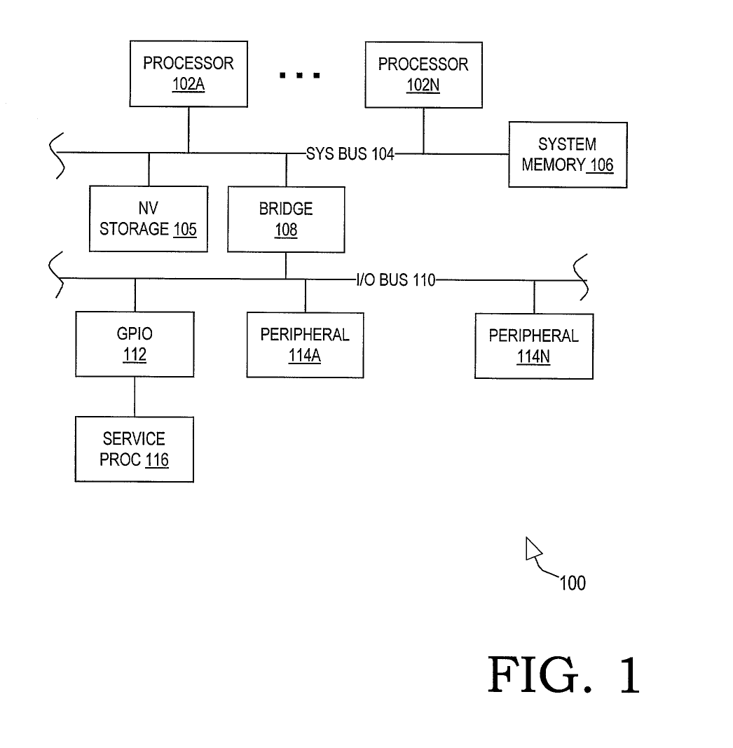

Turning now to the drawings, FIG. 1 is a block diagram of selected features of a data processing system suitable for implementing an embodiment of the present invention. In the depicted embodiment, system 100 includes a set of main processors 102A through 102N (generically or collectively referred to as processor(s) 102) that are connected to a system bus 104. A common system memory 106 is accessible to each processor 102 via system bus 104. The system memory is typically implemented with a volatile storage medium such as an array of dynamic random access memory (DRAM) devices. Because each processor 102 has substantially equal access to system memory 106 (i.e., the memory access time is substantially independent of the processor), the depicted architecture of system 100 is frequently referred to as a symmetric multiprocessor system.

A non-volatile storage element (NVM) 105 is also connected to system bus 104. NVM 105 is typically implemented with a flash memory card although other implementations may employ an alternative programmable non-volatile element such as a conventional electrically erasable programmable read only memory (EEPROM). NVM 105 typically contains code that is executed by processor 102 immediately following a power-on or hardware reset event. The NVM code typically includes the system's POST/BIOS code. Modifications to a system's POST/BIOS code require either programming the content of NVM 105 or replacing the device with an alternative device. From a cost perspective, it is generally preferable to update or otherwise modify the contents of NVM 105 using an automated process that does not require a technician or other personnel to physically open the system. The present invention contemplates a syste and method for doing so without jeopardizing system security.

In system 100, a bus bridge 108 provides an interface between system bus 104 and an I/O bus 110 to which one or more peripheral devices 114A through 114N (generically or collectively referred to as peripheral device(s) 114) as well as a general purpose I/O (GPIO) port are connected. Peripheral devices 114 may include devices such as a graphics adapter, high-speed network adapter, hard-disk controller, and the like. I/O bus 110 is typically compliant with one of several industry standard I/O bus specifications including, as an example, the Peripheral Components Interface (PCI) bus as specified in PCI Local Bus Specification Rev 2.2 by the PCI Special Interest Group (www.pcisig.com).

The depicted embodiment of SMP system 100 includes a service processor 116 connected to GPIO port 112. Service processor 116 is used to provide support for low-level system functions such as power monitoring, cooling fan control, and so forth, hardware error logging, and so forth.

Portions of the present invention may be implemented as a sequence of processor executable instructions, stored on a computer readable medium, for programming or flashing a non-volatile storage element such as a flash memory card in a data processing system stored on a computer readable medium. During execution, portions of the code may reside in a volatile storage element such as the system memory 106 depicted in FIG. 1 or an external or internal cache memory (not depicted) of processors 102. At other times, portions of the code may be stored on a non-volatile storage medium such as a floppy diskette, hard disk, CD ROM, DVD, magnetic tape, or other suitable storage medium.

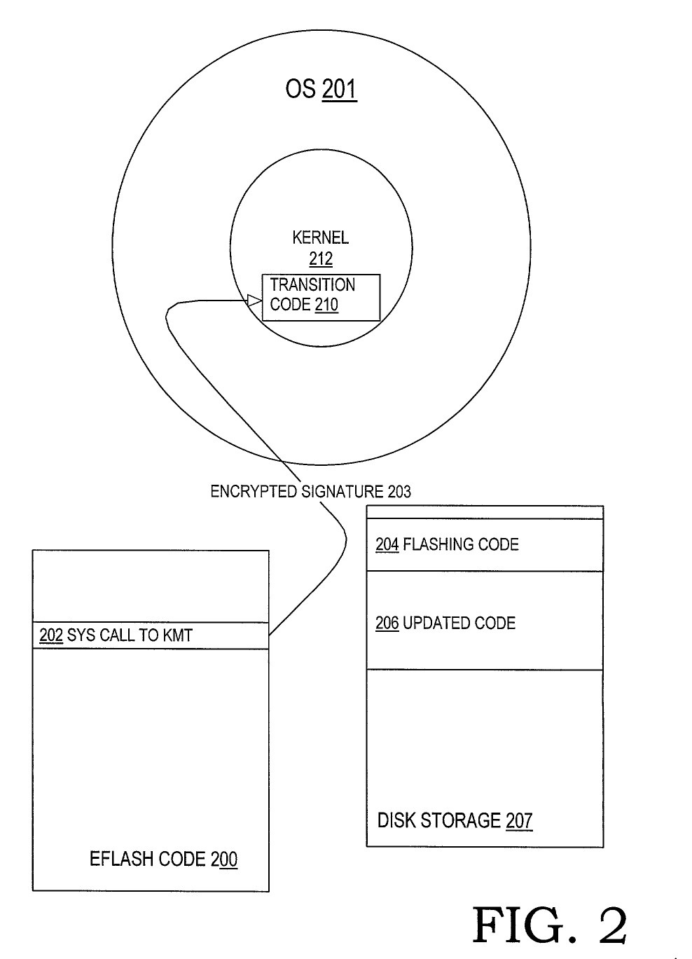

Turning now to FIG. 2, a conceptual illustration of computer code (software) for loading a system non-volatile storage element according to one embodiment of the present invention is depicted. The drawing illustrates an operating system 201 that includes an operating system kernel 212. Operating system 201 refers to software modules within the data processing system that govern the control of system resources including processors 102, system memory 106, peripheral devices 114, and so forth. Operating system 201 also provides a memory management framework in which one or more application programs can execute on a single system. Operating system 201 is exemplified by commercially distributed operating systems including, as examples, the Linux® operating system, the Windows® family of operating systems from Microsoft Corporation, and the AIX family of operating systems from IBM Corporation.

Kernel 212 represents a core subset of operating system 201 that contains well-trusted code capable of accessing and modifying portions of memory containing data structures that define the framework under which application programs running on the system operate. Kernel 212, for example, may include code for accessing the I/O space of system 102 and may be responsible for establishing and maintaining descriptor tables and other data structures that effectively partition the system memory into portions dedicated to each application program.

Because kernel 212 is capable of alternating fundamental operational characteristics of system 102, operating system 201 limits access to it. An application program executing outside of the privileged-mode (in the user space), can only access code in kernel 212 through carefully controlled subroutines that prevent or severely restrict direct access to core data structures. Operating systems may include more than two levels of security or privilege to provide varying levels of access to different pieces of code. The depicted embodiment of operating system 201 is shown as a ring that contains an inner ring representing operating system kernel 212 to emphasize the multiple privilege level organization of operating system 201.

FIG. 2 further illustrates an application program, referred to herein as eflash program 200, designed to initiate and perform flash programming of NVM 105. As an application program, eflash program 200 is initiated after operating system 201 is up and running. Because eflash program 200 is a non-privileged, user application that runs under the operating system's protected-mode, it is referred to herein as the “user portion” of the NVM programming software according to the present invention. Executing the transition from protected-mode to real-mode that is necessary to flash NVM 105 in at least some operating systems, eflash program 200 must transfer from non-privileged-mode into kernel-mode using a system call or device driver. Eflash program 200 as depicted in FIG. 2 includes a system call portion 202 that performs this transfer. System call 202 accesses transition code 210 in kernel 212. In other embodiments, eflash program 200 may invoke a device driver instead of a system call to access transition code 210. Transition code 210 preferably includes just the code necessary to accomplish the transition from protected-mode to real-mode that is required prior to re-programming NVM 105. By minimizing the amount of code within kernel 212, the present invention attempts to reduce the frequency with which the kernel must be re-compiled.

As its name implies, transition code 210 transitions the system to a real-mode operating environment in which substantially all system resources, including the entire range of system memory 106, are available to the executing process. Accordingly, the system must be able to authorize that transition code 210 is being invoked by an authorized requestor. Otherwise, an unauthorized process could invoke transition code 210 and, once the system was in real-mode, have unrestricted access to the entire system memory and other system resources. To insure proper authorization, one embodiment of the invention establishes a public key/private key pair that is used to ensure the necessary authorization.

To use the public key/private key pair, one embodiment of eflash code 200 generates a digital signature before executing the system call 202. The digital signature may itself be indicative of the data processing system on which the code is executing. Dynamic information such as the time of day may also be incorporated into the digital signature to render any unauthorized “sniffing” of the encrypted signature ineffective. The signature could be generated algorithmically, for example, from information related to the properties of the current execution (such as the hostname and process ID in addition to the time of day). Alternatively, the digital signature could comprise a random number, generated perhaps by transition code 210, that is passed to eflash code 200. Eflash code 200 would then encrypt the random number using the private key and pass the encrypted random number to transition code 210 with the system call. The transition code 210 could then authorize the requester by decrypting the random number and comparing it to the original random number.

The digital signature is then encrypted using the private key. In public key/private key encryption, the public key and private key are generated using the same algorithm. The private key is kept securely with its owner while the public key, as its name suggests, is made public. Information that is encrypted using one of the keys can only be decrypted using the other key. In environments where the operating system is an open source operating system (such as Linux®), the private key is provided to the user portion (eflash portion 200) while the public key is given to the kernel portion (i.e., transition code 210). Thus, the signature is encrypted by the user portion 200 using the private key.

The encrypted signature 203 is then passed to the kernel portion as a parameter in system call 202 and decrypted by the kernel portion using the public key. From the decrypted signature, kernel portion 210 of the code is configured to determine whether the signature was generated by a system authorized to program or re-program NVM. In an embodiment that uses system execution information to generate the signature, the decrypted signature should identify the appropriate execution. In an embodiment using random numbers, the decrypted random number should match the original random number passed to eflash program 200. In any case, if the decrypted signature verifies the user process as authorized to update NVM 105, transition code 210 may then complete the transition of the data processing system from a protected-mode environment to a real-mode environment and invoke real-mode flashing code to perform the actual flashing of NVM 105. The flashing code 204 configured to perform the actual flashing of the NVM 105 and the updated code 206 representing the code to be programmed into NVM 105 by flashing code 204 are typically copied from disk storage represented in FIG. 2 by reference numeral 207 into system memory 106 by transition code 210 before the code is invoked. Disk storage 207 may comprise one of the peripheral devices 114 connected to system 100 or a remote disk storage device such as a network attached storage (NAS) box.

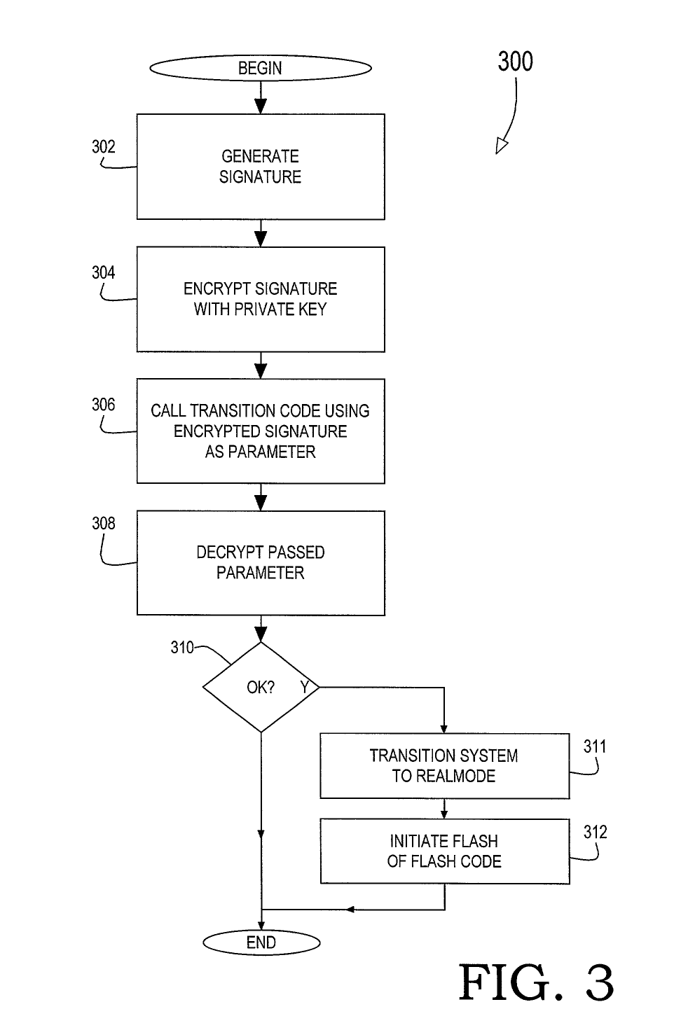

Turning now to FIG. 3, a flow diagram is presented to illustrate a method 300 by which computer code is used to program an NVM storage device in a data processing system according to one embodiment of the present invention. Initially, a user portion of code generates (block 302) a digital signature as described above. The digital signature may be generated from information indicative of the data processing system and/or the current execution including time information that renders the signature valid for only a predetermined duration, which may be arbitrarily made as short as desired to maximize security.

The user portion of the code then encrypts (block 304) the digital signature according to a pre-generated private key. The encrypted key is then passed to the kernel portion of the code as a parameter of a system call or device driver used to call (block 306) the kernel portion of the code. The kernel portion then decrypts (block 308) the signature according to a public key generated in conjunction with the private key and determines (block 310) if the decrypted signature identifies the user portion as belonging to someone authorized to update the flash code. If the signature authorizes the user portion, the kernel code transitions (block 311) the system to real-mode before invoking real-mode flashing code. The flashing code then initiates (block 312) the programming of the NVM storage device. In this manner, the system enters real-mode only if prompted to do so by an authorized requestor thereby preventing unauthorized requesters from gaining access to trusted system resources.

It will be apparent to those skilled in the art having the benefit of this disclosure that the present invention contemplates a system and method for securely enabling the automated re-programming of POST and BIOS code in a data processing system. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A computer program product comprising processor executable instructions for programming a non-volatile storage element in a data processing system, the instructions being stored on a computer readable medium, comprising:
computer code means for encrypting a digital signature using a first encryption key;
computer code means for passing the encrypted signature to a kernel routine;
computer code means, responsive to successfully decrypting the encrypted signature using a second encryption key, for transitioning the data processing system from a protected-mode to a real-mode; and
real-mode computer code means for flash programming the non-volatile storage element.

2. The computer program product of claim 1, wherein the code means for encrypting the digital signature is non-privileged code.

3. The computer program product of claim 2, wherein the code means for passing the encrypted signature to the kernel routine comprises code means for executing a system call from the non-privileged code and passing the signature as a parameter of the system call.

4. The computer program product of claim 1, wherein the first encryption key is a private key and the second encryption key is a public key, wherein the public key and private key are generated from a common algorithm.

5. The computer program product of claim 1, further comprising code means for generating the digital signature, wherein the digital signature includes information that is indicative of the data processing system.

6. The computer program product of claim 5, wherein the digital signature is generated based at least in part upon dynamic information.

7. The computer program product of claim 6, wherein the digital signature is generated at least in part based further upon information including a corresponding hostname and process ID.

8. The computer program product of claim 1, further comprising code means for generating a random number as the digital signature.

9. A data processing system including at least one processor, memory, and input means connected to a common bus, wherein the system memory contains at least a portion of a sequence of computer executable instructions for programming a non-volatile storage element of the data processing system, the instructions comprising:
computer code means for encrypting a digital signature using a first encryption key;
computer code means for passing the encrypted signature to a kernel routine;
computer code means, responsive to successfully decrypting the encrypted signature using a second encryption key, for transitioning the data processing system from a protected-mode to a real-mode; and
real-mode computer code means for flash programming the non-volatile storage element.

10. The data processing system of claim 9, wherein the code means for encrypting the digital signature is non-privileged code.

11. The data processing system of claim 10, wherein the code means for passing the encrypted signature to the kernel routine comprises code means for executing a system call from the non-privileged code and passing the signature as a parameter of the system call.

12. The data processing system of claim 9, wherein the first encryption key is a private key and the second encryption key is a public key, wherein the public key and private key are generated from a common algorithm.

13. The data processing system of claim 9, further comprising code means for generating the digital signature, wherein the digital signature includes information that is indicative of the data processing system.

14. The data processing system of claim 13, wherein the digital signature is generated based at least in part upon dynamic information.

15. The data processing system of claim 14, wherein the digital signature is generated at least in part based further upon information including a corresponding hostname and process ID.

16. The data processing system of claim 9, further comprising code means for generating a random number as the digital signature.

17. A method of programming a non-volatile storage element in a data processing system, comprising:
encrypting a digital signature using a first encryption key;
passing the encrypted signature to a kernel code routine;
responsive to successfully decrypting the encrypted signature using a second encryption key, transitioning the data processing system from a protected-mode to a real-mode with the kernel code routine; and
flash programming the non-volatile storage element in real mode.

18. The method of claim 17, wherein encrypting the digital signature comprises encrypting the digital signature with non-privileged code.

19. The method of claim 18, wherein passing the encrypted signature to the kernel routine comprises executing a system call from the non-privileged code and passing the signature as a parameter of the system call.

20. The method of claim 17, wherein the first encryption key is a private key and the second encryption key is a public key, wherein the public key and private key are generated from a common algorithm.

21. The method of claim 17, further comprising generating the digital signature, wherein the digital signature includes information that is indicative of the data processing system.

22. The method of claim 21, wherein the digital signature is generated based at least in part upon dynamic information.

23. The method of claim 22, wherein the digital signature is generated at least in part based further upon information including a corresponding hostname and process ID.

24. The method of claim 17, further comprising code means for generating a random number as the digital signature.
